(19) United States
(12) Patent Application Publication
(10) Pub. No.: US 2024/0265558 A1
(43) Pub. Date: Aug. 8, 2024

(54) METHOD FOR DETECTING CARGO

(71) Applicant: ZF CV Systems Global GmbH, Bern (CH)

(72) Inventors: Dennis Buchner, Sarstedt (DE); Tobias Klinger, Springe (DE); Daniel Pfefferkorn, Hannover (DE); Thomas Wolf, Barsinghausen (DE)

(21) Appl. No.: 18/639,653

(22) Filed: Apr. 18, 2024

Related U.S. Application Data
(63) Continuation of application No. PCT/EP2022/076572, filed on Sep. 23, 2022.

(30) Foreign Application Priority Data
Oct. 26, 2021 (DE) 10 2021 127 789.2

(51) Int. Cl. G06T 7/50; G06T 7/62

(52) U.S. Cl. CPC G06T 7/50; G06T 7/62; G06T 2207/10028; G06T 2207/30112

(57) ABSTRACT

A method is for detecting a cargo within a cargo compartment. The interior of the compartment containing the cargo is captured via a camera. The captured image information is subjected to automatic image processing. The algorithm underlying the image processing contains a program part or operator for edge detection, which determines edges of the cargo that are recognizable from the image information by the camera. Via the algorithm, the model of the cargo described by the current edge configuration of the cargo is then fitted into a model described by the edges of the compartment, namely by performing a comparison of the recognizable edges of the cargo and their edge lengths with the edges of the unladen compartment and their edge lengths, or with the edges of the compartment in a previous loaded state and the associated edge lengths. From this, the space occupied by the cargo is determined.

### CROSS-REFERENCE TO RELATED APPLICATIONS

This application is a continuation application of international patent application PCT/EP2022/076572, filed Sep. 23, 2022, designating the United States and claiming priority from German application 10 2021 127 789.2, filed Oct. 26, 2021, and the entire content of both applications is incorporated herein by reference.

### TECHNICAL FIELD

The disclosure relates to a method for detecting a cargo within a cargo compartment, in which the interior of the cargo compartment containing the cargo is captured as an image using at least one camera, that is, using the image sensor of a camera, and the captured image information undergoes automatic image processing.

### BACKGROUND

The monitoring of cargo compartments, in particular via electronic systems, is becoming increasingly widespread given today's traffic flows and the requirements on the logistics of goods. In particular, the cargo compartments of trucks and containers are the focus of fleet operators, freight forwarders and mail order companies in this regard and must be used as efficiently as possible. For this purpose, the loading and unloading processes must also be planned, depending on the fill level of the cargo compartment.

Such monitoring is often carried out by measuring, scanning or otherwise identifying the objects or cargo parts that are loaded into a cargo compartment before or during loading. Methods are known in which, for example, cameras are mounted on forklifts, which scan the individual pieces of cargo during loading and add the results to obtain a total load or a filling level within the cargo compartment. Other solutions work with RFID tags/labels (RFID=radio frequency identification or radio wave identification) attached to cargo parts, which are detected during loading or within the cargo compartment by appropriate antennas in the cargo compartment or, for example, on the ramp in the loading area. This means, however, that determining a spatially defined loading state within the cargo compartment is only possible to a limited extent. In addition, such methods require a relatively large amount of equipment in the entire infrastructure surrounding the cargo, that is, at loading points, on ramps, loading vehicles, et cetera, which of course must first be collated and evaluated in a suitable form.

In the prior art, methods are also known which can spatially determine and identify individual cargo parts via camera-assisted measurements. For example, DE 10 2016 011 788 DE discloses a method for detecting the cargo in a vehicle via an image sensor or a camera, in which a cargo is identified and a storage location of the respective cargo in the vehicle is determined automatically on the basis of acquired image data from the image sensor. For this purpose, two images are captured at different times or events and compared with each other via an automatic evaluation of a difference image. The cargo determined in each case is identified via barcodes or transponders and thus the storage location is detected. The identified cargo and storage location are stored in a database.

The disadvantage with this is that the cargo compartment must be divided into known sections, for example into shelving units, in order to create clear difference images. A cargo within an arbitrarily configured cargo compartment without divisions provided is very difficult to determine with this method.

In addition, this and many other known methods of detecting cargo parts via cameras or image sensors suffer the disadvantage that the detection can be greatly affected by the prevailing light conditions. Especially for cargos of different sizes and shapes, differentiation is extremely difficult under changing lighting and lighting conditions.

### SUMMARY

It is an object of the present disclosure to provide an improved method for cargo identification and cargo detection, which is applicable to arbitrarily configured cargo compartments, which is not influenced by changing lighting conditions and can be implemented as universally and simply as possible with regard to its hardware and electronic requirements.

This object is, for example, achieved by a method for detecting a cargo within a cargo compartment. The method includes: capturing an interior of the cargo compartment containing the cargo as an image using at least one camera and automatically image processing captured image information, wherein an algorithm underlying the image processing includes a program part or operator for edge detection, wherein the program part or operator determines edges of the cargo from the image information that is visible and recognizable from a location of the at least one camera; fitting, also via the algorithm, a first model of the cargo described by a current edge configuration of the cargo into a second model described by the edges of the cargo compartment by performing a comparison of the recognizable edges of the cargo and of edge lengths of the recognizable edges of the cargo with: the edges of the cargo compartment in an unladen state and edge lengths of the edges of the cargo compartment in the unladen state, or the edges of the cargo compartment in a previous loaded state and edge lengths of the edges of the cargo compartment in the previous loaded state; and, determining the cargo space occupied by the cargo on a basis of the fitting. A device for carrying out the method and a vehicle having such a device are also disclosed.

The method according to the disclosure is characterized in that the algorithm underlying the image processing includes a program part or operator for edge detection, via which edges of the cargo visible from the image information and recognizable from the location of the camera are determined currently in each case. Furthermore, via the algorithm, the model of the cargo described by the current edge configuration of the cargo is then fitted into a model described by the edges of the cargo compartment, namely by performing a comparison of the recognizable edges of the cargo and their edge lengths with the edges of the unladen cargo compartment and their edge lengths or with the edges of the cargo compartment in a previous loaded state and the associated edge lengths, from which the cargo space occupied by the cargo is determined and identified.

Edge detection or edge extraction as such is known and is usually part of a segmentation of elements in digital image processing. In this case, a correspondingly configured algorithm is used with a view to separating two-dimensional regions in the image from one another if they differ sufficiently in color or gray-scale value, brightness or texture along straight or curved lines. Special edge operators (edge detectors) are used to detect these regions and provide data that can be used to describe the intervening edges. In image processing, the so-called Prewitt operator or the Canny algorithm are known forms of edge detectors. Edge detectors are also used in photogrammetry and cartography, for example, to determine edges of objects or terrain from aerial images.

In various methods according to the disclosure, edge detection is now used to detect edges of cargo parts in a cargo compartment, to determine their lengths and, via predetermined models of cargo items and of the cargo compartment as such, to identify a loading situation that allows the position, quantity and volume of a load in a cargo compartment to be determined. The predetermined cargo compartment geometry is compared with the geometry and the currently measured volumes of the cargo items. This already makes it clear that the present disclosure involves not only a simple transfer of known methods to another field of application being carried out, but in fact a new and inventively adapted application of the edge detection known only in the two-dimensional domain to the interpretation of the loading situation in a three-dimensional space.

Various methods according to the disclosure also enable an accurate and sufficiently clear assessment of the situation in a cargo compartment with a relatively small amount of data to be processed. In addition, using the method of edge detection adapted according to the disclosure, the disadvantages and sources of error arising in the use of image processing according to conventional methods due to different lighting situations or the effects of reflection are avoided. This provides a very robust detection of the condition of the cargo compartment, which is only slightly affected by changing lighting conditions and changing brightness.

An embodiment of the disclosure includes displaying the cargo space occupied by the cargo, determined according to the method, in the form of a graphical representation on a display device or an interface, in particular on a screen. Such a configuration results in an extraordinarily simple operation of the system without lengthy training. It allows the respective user to easily interpret the results of the cargo compartment situation determined by the method according to the disclosure and to respond to it accordingly.

In an embodiment of the disclosure, by using and starting from the graphical representation, interventions in or changes to the edge detection implemented by the program part or the operator as well as calibrations can be carried out, in particular manual interventions, changes or calibrations. This allows simulations of loading states or representations of changed load positions to be carried out as well as possible corrections to the detected load state, for example, if the user him/herself has different or better knowledge of a currently changed loading situation.

An embodiment of the disclosure includes the interior of the cargo compartment containing the cargo being captured as an image using at least one camera under illumination with visible or infrared light. Even if the method behaves very robustly with respect to differences in brightness, additional illuminations, in particular adapted to the image sensor of the camera, can have a positive effect on the determination of edges and lengths. Using infrared light requires a camera with an image sensor that also responds to infrared radiation.

In a further embodiment, the algorithm underlying the image processing can display additional lines projected into the cargo compartment in the graphical representation on the display device or interface. This makes it easier for the user, that is, the loading manager or the freight forwarder, to orient the display. It also facilitates the interpretation of the graphical representation on the interface or screen. This also makes it easier to see in which area the load limits are exceeded or where there is enough space left to relocate or rearrange the load. The same applies to a further embodiment, in which the algorithm underlying the image processing can display additional grid lines or ordering lines, projected into the cargo compartment, in the graphical representation on the display device or interface.

A further embodiment includes providing the cargo space occupied by the cargo, determined according to the method, as processable, in particular digital, information for storage in various data processing systems, in particular for use in control devices and for use and processing within a data communication system. For example, the necessary data, which is also used to provide the graphical representation, can be loaded into a data cloud or sent via telecommunications equipment to a headquarters of a freight carrier, which is then able to monitor the cargo compartment or the loading situation in a truck during its different travel situations.

A further embodiment includes the implementation of the method for detecting a cargo being triggered in an event-driven manner, in particular by sensor signals triggered by loading operations or cargo compartment openings. In such a configuration, the detection of the cargo using the method according to the disclosure can be triggered by signals from a CAN bus of a vehicle, which transmits corresponding signals or events throughout the vehicle. The computing unit, in which the algorithm for carrying out cargo detection is stored as a program, is then embedded in an appropriate manner in a data infrastructure via CAN bus. In this way, events can also be used as triggers in which, for example, slippage or shifting of the load is detected via a separate sensor system in the cargo compartment. Via appropriate sensors, events such as the presence of smoke, the occurrence of spillage or changes in dumping angle, changed temperatures or humidity et cetera, can also be used as triggers for the detection according to the disclosure. Of course, in certain cases the method according to the disclosure also allows changes in the dumping angle to be detected and corresponding reactions to be derived from the results.

In a further embodiment, in the case of an event triggering the implementation of the sequence of the method steps for detecting a cargo or for the case that determination of the cargo space occupied by the cargo exceeds predetermined threshold values, a warning message or a warning signal is output via the display device or interface. This allows direct information to be sent to a driver, a loading supervisor or a central monitoring station.

In a further embodiment, the image processing and the associated algorithm are implemented at least in part as an app, that is, as application software or computer programs for data processing devices, in particular mobile data processing devices such as mobile phones or tablets, wherein the graphical display takes place on these data processing devices and interventions in or changes to the method sequence as well as calibrations, in particular manual interventions, changes or calibrations, can be carried out from such a data processing device. With such a configuration, access to the cargo monitoring and service in the corresponding facilities can be made considerably simpler, since only the cargo compartments or the vehicles need to be equipped with a camera and an associated data transmission, wherein the transmitted raw data can then be processed in accordance with the method in the data processing devices.

In a further embodiment facilitating the detection of the cargo according to the disclosure, structures identifiable by the camera and recognizable as “artificial” edges for the edge recognition can be generated by light beams projected into the cargo compartment or by line-shaped markings applied to the walls or floor of the cargo compartment. Here, for example, lasers can generate light beams that are recognized as edges by the camera or by the edge detection integrated in the algorithm. Likewise, for example, markings consisting of adhesive strips may be applied to the floor or the side walls of the cargo compartment, which are interpreted in the same way as an edge by the edge detection. Such a procedure of course facilitates the evaluation and interpretation of the volumes occupied by the cargo in relation to the limits or boundary surfaces of the cargo compartment.

To carry out the method, a particularly suitable device accordingly includes a camera mounted in a cargo compartment, which captures the interior of the cargo compartment containing the cargo and transfers the captured image information to a computing unit contained in a data processing device for automatic image processing, wherein an image processing algorithm is programmed in the computing unit, which contains program parts or operators for edge recognition, for fitting the cargo model into the cargo compartment model and for comparing the edges and edge lengths of the cargo and the unladen or pre-loaded cargo compartment, and to determine from this the cargo space occupied by the cargo.

Such a device is particularly useful in transport vehicles, in particular in commercial vehicles, more particularly in trucks or trailer vehicles. Provided that the dimensions of the available cargo compartments are known, a simulation of a loading configuration can then be carried out in advance and a schedule for loading and unloading at successive stops can be prepared.

### BRIEF DESCRIPTION OF DRAWINGS

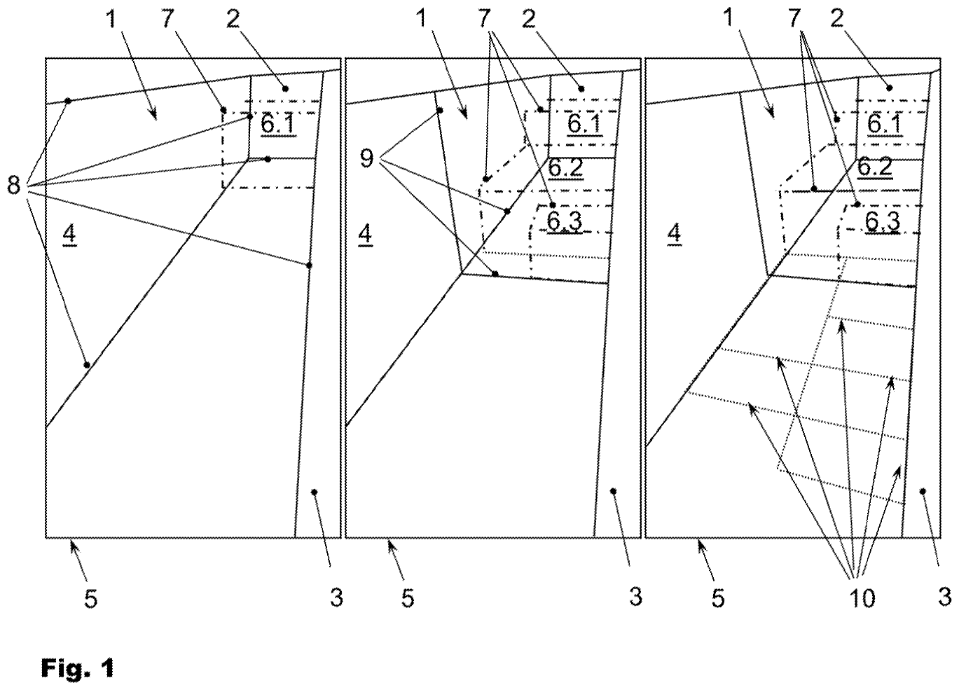

The invention will now be described with reference to the single FIGURE of the drawing (FIG. 1) which shows a sketched view of a graphical display on a screen looking into the interior of a cargo compartment.

### DETAILED DESCRIPTION

FIG. 1 shows a sketched view of a graphical display on a screen looking into the interior of a cargo compartment 1, namely looking towards the front wall 2 from its rear tail lift. For ease of comparability, the diagram contains the same view of the load compartment in three side-by-side views, that is, in three adjacent images of a camera positioned in the upper right corner of the rear tailgate of the cargo compartment 1 in the direction of travel. This location is particularly well suited for the arrangement of such a camera, as the entire cargo compartment up to the front wall is then located in the viewing range.

The left-hand image differs from the adjacent images in that other parts of the cargo and a different arrangement of the cargo are shown.

The right boundary wall 3, the left boundary wall 4, the loading surface or floor 5 and the front boundary wall 2 can all be identified. Also recognizable is the cargo, namely various objects or various cargo parts 6.1, 6.2 and 6.3 distributed over the cargo compartment floor 5. This is the cargo compartment of a truck, the loading surface of which is fitted with a framework of struts and battens, which is covered with a tarpaulin.

According to the disclosure, the captured image information is subjected to automatic image processing, wherein the algorithm underlying the image processing includes an operator for edge detection, via which edges 7 of the cargo visible from the image information and recognizable from the location of the camera are determined. In all three views of the graphical representations selected here, all the edges of the cargo are represented by dash-dotted lines, but for reasons of clarity, they are not provided with reference signs everywhere. The current edge configuration of the dash-dotted lines, interpreted according to the method, thus describes the model or the graphical representation of the cargo.

The operator for edge detection determines edges 8, which are also visible from the image information and can be recognized from the location of the camera. These edges represent the model of the cargo compartment 1 with sufficient accuracy and are shown here only in the left image for clarity.

Via the algorithm, the model described by the current configuration of the edges 7 of the cargo 6.1, 6.2 and 6.3 is fitted into the model described by the edges 8 of the cargo compartment 1 by performing a comparison of the recognizable edges of the cargo 6.1, 6.2 and 6.3 and their edge lengths with the edges 8 of the cargo compartment and their edge lengths.

This is carried out in relation to the unladen cargo compartment and its edge lengths as well as with the visible edges of the cargo compartment, reduced by corresponding edge lengths of a subsequently loaded cargo. From this, the cargo space occupied by the cargo and also the remaining cargo space are determined.

In the middle view of FIG. 1, the lines 9 additionally projected on the screen in the cargo compartment show the boundaries or the volume occupied by the additional cargo parts 6.2 and 6.3 loaded after the cargo parts 6.1. Again, the lines 9 are shown only in the middle view and not in the right-hand view to ensure clarity.

In the right-hand view of FIG. 1, further dotted lines 10 projected into the cargo compartment or on the cargo compartment floor 5 are shown on the screen as grid lines or ordering lines, which show the user or the loading supervisor in a simulation how an optimized loading configuration for further cargo parts (for example, pallet cages) with their dimensions specified might look.

It is understood that the foregoing description is that of the preferred embodiments of the invention and that various changes and modifications may be made thereto without departing from the spirit and scope of the invention as defined in the appended claims.

### List of Reference Signs (Part of the Description)

1 cargo compartment
2 front wall of the cargo compartment
3 right-hand boundary wall of the cargo compartment
4 left-hand boundary wall of the cargo compartment
5 floor of the cargo compartment
6.1 cargo part/cargo
6.2 cargo part/cargo
6.3 cargo part/cargo
7 edge of the cargo/the cargo part
8 edge of the cargo compartment
9 projected line (occupied volume)
10 projected line (additional load simulation)

1. A method for detecting a cargo within a cargo compartment, the method comprising:
capturing an interior of the cargo compartment containing the cargo as an image using at least one camera and automatically image processing captured image information, wherein an algorithm underlying the image processing includes a program part or operator for edge detection, wherein the program part or operator determines edges of the cargo from the image information that is visible and recognizable from a location of the at least one camera;
fitting, also via the algorithm, a first model of the cargo described by a current edge configuration of the cargo into a second model described by the edges of the cargo compartment by performing a comparison of the recognizable edges of the cargo and of edge lengths of the recognizable edges of the cargo with:
the edges of the cargo compartment in an unladen state and edge lengths of the edges of the cargo compartment in the unladen state, or
the edges of the cargo compartment in a previous loaded state and edge lengths of the edges of the cargo compartment in the previous loaded state; and,
determining the cargo space occupied by the cargo on a basis of said fitting.

2. The method of claim 1, wherein the cargo space occupied by the cargo determined according to the method is displayed as a graphical representation on a display device or an interface.

3. The method of claim 2, wherein, using and starting from the graphical representation, interventions in or changes to the edge detection, implemented by the program part or the operator, and calibrations can be carried out.

4. The method of claim 3, wherein manual interventions, changes or calibrations can be carried out.

5. The method of claim 1, wherein the interior of the cargo compartment containing the cargo is captured as the image using at least one camera under illumination with visible or infrared light.

6. The method of claim 2, wherein the algorithm underlying the image processing is configured to display additional lines, projected into the cargo compartment, in the graphical representation on the display device or interface.

7. The method of claim 2, wherein the algorithm underlying the image processing is configured to display grid lines or ordering lines projected into the cargo compartment, in the graphical representation on the display device or interface.

8. The method of claim 1, wherein the cargo space occupied by the cargo determined according to the method is provided as processable information for storage in data processing systems.

9. The method of claim 8, wherein the processable information includes digital information.

10. The method of claim 1, wherein the cargo space occupied by the cargo determined according to the method is provided as processable information for use in control devices and for use and processing within a data communication system.

11. The method of claim 1, wherein an implementation of the method for detecting a cargo is triggered in an event-driven manner.

12. The method of claim 1, wherein an implementation of the method for detecting a cargo is triggered by sensor signals triggered by loading operations or cargo compartment openings.

13. The method of claim 1, wherein, in a case of an event triggering an implementation of the method for detecting a cargo or in a case that determination of the cargo space occupied by the cargo exceeds predetermined threshold values, a warning message or a warning signal is output via a display device or interface.

14. The method of claim 1, wherein the image processing and the associated algorithm are implemented at least in part as an app for a data processing device, a graphic representation, if any, takes place on the data processing device and interventions in or changes to the method sequence as well as calibrations are configured to be carried out from the data processing device.

15. The method of claim 14, wherein the data processing devices include at least one of mobile phones and tablets.

16. The method of claim 1, wherein structures determinable by the at least one camera and recognizable as the edges for the edge recognition are configured to be generated by light beams projected into the cargo compartment or by line-shaped markings applied to the walls or floor of the cargo compartment.

17. The method of claim 2, wherein the display device or interface is a screen.

18. A device comprising:
a data processing unit including a computing unit and a non-transitory computer readable storage medium having program code stored thereon;
a camera mounted in a cargo compartment, said camera being configured to capture an interior of the cargo compartment containing the cargo and to transfer captured image information to a computing unit contained in a data processing device for automatic image processing;
wherein an image processing algorithm is stored on said non-transitory computer readable storage medium, wherein said image processing algorithm includes program parts or operators for edge recognition, for fitting a cargo model into a cargo compartment model and for comparing edges and edge lengths of the cargo and the unladen or pre-loaded cargo compartment, and from this determines a cargo space occupied by the cargo;
said program code, when executed by said computing unit, being configured to:
capture the interior of the cargo compartment containing the cargo as an image using said camera and automatically image processing captured image information, wherein an algorithm underlying the image processing includes a program part or operator for edge detection, wherein the program part or operator determines the edges of the cargo from the image information that is visible and recognizable from a location of the camera;
fit, also via the algorithm, a first model of the cargo described by the current edge configuration of the cargo into a second model described by the edges of the cargo compartment by performing a comparison of the recognizable edges of the cargo and of the edge lengths of the recognizable edges of the cargo with:
the edges of the cargo compartment in an unladen state and edge lengths of the edges of the cargo compartment in the unladen state, or
with the edges of the cargo compartment in a previous loaded state and edge lengths of the edges of the cargo compartment in the previous loaded state; and,
determine the cargo space occupied by the cargo on a basis of said fitting.

19. A vehicle comprising the device of claim 12.

20. The vehicle of claim 19, wherein the vehicle is at least one of a commercial vehicle, a truck, and a trailer.
